(19) United States
(12) Patent Application Publication
(10) Pub. No.: US 2026/0072540 A1
(43) Pub. Date: Mar. 12, 2026

(54) TOUCH INPUT DEVICE, IMAGE DISPLAY DEVICE INCLUDING THE SAME AND ELECTRONIC DEVICE INCLUDING DISPLAY DEVICE

(71) Applicant: Samsung Display Co., LTD., Yongin-si (KR)

(72) Inventor: Won Sang PARK, Yongin-si (KR)

(21) Appl. No.: 19/204,976

(22) Filed: May 12, 2025

(30) Foreign Application Priority Data
Sep. 6, 2024 (KR) 10-2024-0121417

(51) Int. Cl. G06F 3/041; G06F 3/0354; G06F 3/038; G06F 3/044

(52) U.S. Cl. CPC G06F 3/04162; G06F 3/03545; G06F 3/0383; G06F 3/04166; G06F 3/0441; G06F 2203/04106; G06F 2203/04108

(57) ABSTRACT

A touch input device includes: a first signal transceiver including one end forming a pen tip and formed as a pen lead type; an insulating member which covers an outer surface of a main body of the first signal transceiver in a circular or polygonal cylindrical shape; a second signal transceiver which covers the insulating member in a coil shape; and a touch input controller setting a touch driving signal reception period of the first signal transceiver and a touch data signal transmission period of the first and second signal transceivers and sequentially and repeatedly controlling a touch driving signal reception operation of the first signal transceiver and a touch data signal transmission operation of the first and second signal transceivers.

This application claims priority to Korean Patent Application No. 10-2024-0121417, filed on Sep. 6, 2024, and all the benefits accruing therefrom under 35 U.S.C. § 119, the content of which in its entirety is herein incorporated by reference.

### BACKGROUND

### 1. Field

The disclosure relates to a touch input device and an image display device including the same and an electronic device.

### 2. Description of the Related Art

As the information society develops, demands for display devices for displaying images are increasing in various forms. For example, display devices are applied to various electronic devices such as smartphones, digital cameras, laptop computers, navigation devices, and smart televisions. The display devices may be flat panel display devices such as liquid crystal display devices, field emission display devices, and organic light-emitting display devices. Among these flat panel display devices, an organic light-emitting display device includes light-emitting elements that enable pixels of a display panel to emit light by themselves. Thus, the organic light-emitting display device may display an image without a backlight unit that provides light to the display panel.

Recent display devices support touch input using a user's body part (e.g., a finger) and a touch coordinate sensing function using a touch input device such as an electronic pen. In particular, a display device provides a touch position detection function using a touch input device such as an electronic pen, thereby enabling more precise and accurate detection of a touch position than when only a touch input using a body part such as a finger is detected.

### SUMMARY

Features of the disclosure provide an image display device capable of precisely detecting a touch position of a touch input device such as an electronic pen by a touch sensing unit of a display panel which may sense a touch of a body part such as a finger.

Features of the disclosure also provide a touch input device in which a first signal transceiver of a pencil lead type, a second signal transceiver of a coil type, and a third signal transceiver of a ring type increase the efficiency of touch signal transmission and reception and an image display device including the touch input device.

However, features of the disclosure are not restricted to the one set forth herein. The above and other features of the disclosure will become more apparent to one of ordinary skill in the art to which the disclosure pertains by referencing the detailed description of the disclosure given below.

In an embodiment of the disclosure, there is provided a touch input device including: a first signal transceiver including one end forming a pen tip and formed as a pen lead type; an insulating member which covers an outer surface of a main body of the first signal transceiver in a circular or polygonal cylindrical shape; a second signal transceiver which covers the insulating member in a coil shape; and a touch input controller setting a touch driving signal reception period of the first signal transceiver and a touch data signal transmission period of the first and second signal transceivers and sequentially and repeatedly controlling a touch driving signal reception operation of the first signal transceiver and a touch data signal transmission operation of the first and second signal transceivers.

In another embodiment of the disclosure, there is provided an image display device including: a display panel including a plurality of pixels arranged in an image display area; a touch sensing unit disposed on a front surface of the display panel to sense a touch of a user's body part or a touch input device; a display driving circuit driving the pixels of the image display area; and a touch sensing circuit generating touch coordinate data by detecting a touch position of the user's body part or the touch input device, wherein the touch sensing circuit detects the touch position of the touch input device by supplying touch driving signals to touch electrodes of the touch sensing unit during an uplink period and receiving sensing signals from the touch electrodes during a downlink period, and the touch input device wirelessly receives the touch driving signals through the touch electrodes during a preset touch driving signal reception period and generates a touch data signal and transmits the touch data signal to the touch electrodes during a preset touch data signal transmission period.

In another embodiment of the disclosure, there is provided an electronic device including an image display device, wherein the image display device comprising a display panel including a plurality of pixels arranged in an image display area, a touch sensing unit disposed on a front surface of the display panel to sense a touch of a user's body part or a touch input device, a display driving circuit driving the pixels of the image display area, and a touch sensing circuit generating touch coordinate data by detecting a touch position of the user's body part or the touch input device, wherein the touch sensing circuit detects the touch position of the touch input device by supplying touch driving signals to touch electrodes of the touch sensing unit during an uplink period and receiving sensing signals from the touch electrodes during a downlink period, and the touch input device wirelessly receives the touch driving signals through the touch electrodes during a preset touch driving signal reception period and generates a touch data signal and transmits the touch data signal to the touch electrodes during a preset touch data signal transmission period.

By embodiments of a touch input device and an image display device including the same in embodiments, it is possible to sense a touch of an electronic pen using a touch sensing unit of a display panel, which senses a touch of a user's body part, without including a sensor layer or a digitizer layer. Therefore, according to the touch input device and the image display device including the same in the embodiments, the image display device may be simplified in structure and reduced in thickness, which, in turn, reduces manufacturing costs.

In addition, according to the touch input device and the image display device including the same in the embodiments, it is possible to increase the efficiency of touch signal transmission and reception and further improve touch accuracy by first through third signal transceivers formed in the touch input device. In addition, it is possible to generate and transmit pressure data and tilt data by accurately sensing the pressure applied to the touch input device and the tilt of the touch input device.

However, the effects of the disclosure are not restricted to the one set forth herein. The above and other effects of the disclosure will become more apparent to one of daily skill in the art to which the disclosure pertains by referencing the claims.

### BRIEF DESCRIPTION OF THE DRAWINGS

These and/or other features will become apparent and more readily appreciated from the following description of the embodiments, taken in conjunction with the accompanying drawings in which:

FIG. 1 is a configuration diagram illustrating an embodiment of a touch input device and an image display device including the same according to the disclosure;

FIG. 2 is a plan view of the image display device illustrated in FIG. 1;

FIG. 3 is a detailed side view of the image display device illustrated in FIG. 2;

FIG. 4 is a schematic plan view of an embodiment of a display panel illustrated in FIGS. 1 through 3;

FIG. 5 is a schematic plan view of an embodiment of a touch sensing unit illustrated in FIG. 3;

FIG. 6 is a plan view illustrating the electrical connection structure of touch electrodes and a touch sensing circuit illustrated in FIG. 5;

FIG. 7 is a detailed configuration diagram of an embodiment of the touch input device illustrated in FIG. 1;

FIG. 8 is a cross-sectional view illustrating the arrangement structure of a first signal transceiver, an insulating member, and a second signal transceiver illustrated in FIG. 7;

FIG. 9 is a configuration block diagram specifically illustrating detailed components of the touch input device illustrated in FIG. 7;

FIG. 10 is a configuration block diagram of the embodiment of FIG. 7, sequentially illustrating touch input signal transmission and reception operations in uplink and downlink periods;

FIG. 11 is a detailed configuration diagram of an embodiment of the touch input device illustrated in FIG. 1;

FIG. 12 is a configuration block diagram specifically illustrating detailed components of the touch input device illustrated in FIG. 11; and

FIG. 13 is a configuration block diagram of the embodiment of FIG. 11, sequentially illustrating touch input signal transmission and reception operations in uplink and downlink periods.

### DETAILED DESCRIPTION

The disclosure will now be described more fully hereinafter with reference to the accompanying drawings, in which preferred embodiments of the disclosure are shown. This disclosure may, however, be embodied in different forms and should not be construed as limited to the embodiments set forth herein. Rather, these embodiments are provided so that this disclosure will be thorough and complete, and will filly convey the scope of the disclosure to those skilled in the art.

It will also be understood that when a layer is referred to as being “on” another layer or substrate, it may be directly on the other layer or substrate, or intervening layers may also be present. The same reference numbers indicate the same components throughout the specification.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the disclosure. Similarly, the second element could also be termed the first element.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or. ” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below”or “beneath”may, therefore, encompass both an orientation of above and below.

The terms such as “unit” as used herein are intended to mean a hardware component such as a circuitry that performs a predetermined function. The hardware component may include a field-programmable gate array (“FPGA”) or an application-specific integrated circuit (“ASIC”), for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Each of the features of the various embodiments of the disclosure may be combined or combined with each other, in part or in whole, and technically various interlocking and driving are possible. Each embodiment may be implemented independently of each other or may be implemented together in an association.

Hereinafter, illustrative embodiments will be described with reference to the accompanying drawings.

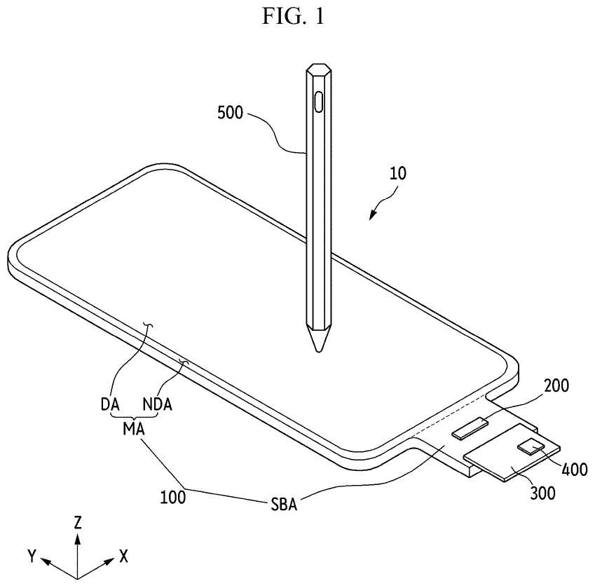

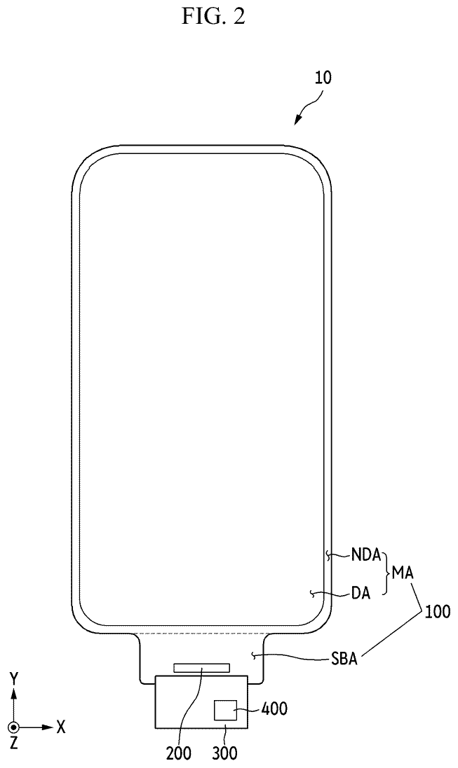

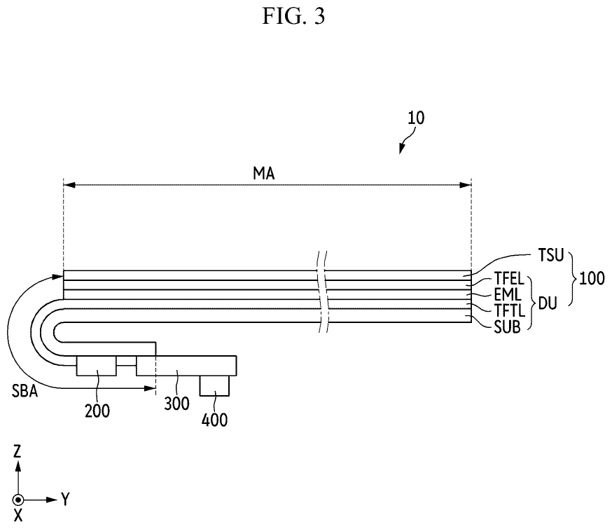

FIG. 1 is a configuration diagram illustrating an embodiment of a touch input device 500 and an image display device 10 including the same according to the disclosure. FIG. 2 is a plan view of the image display device 10 illustrated in FIG. 1. FIG. 3 is a detailed side view of the image display device 10 illustrated in FIG. 2.

Referring to FIGS. 1 through 3, the image display device 10 in the embodiment may be applied to mobile electronic devices such as mobile phones, smartphones, tablet personal computers (“PCs”), mobile communication terminals, electronic notebooks, electronic books, portable multimedia players (“PMPs”), navigation devices, and ultra-mobile PCs (“UMPCs”). In an alternative embodiment, the image display device 10 in the embodiment may be applied as a display unit of a television, a laptop computer, a monitor, a billboard, or an Internet of things (“IoT”) device. In an alternative embodiment, the image display device 10 in the embodiment may be applied to wearable devices such as smart watches, watch phones, glasses-type displays, and head-mounted displays (“HMDs”). In an alternative embodiment, the image display device 10 in the embodiment may be applied to an instrument cluster of a vehicle, a center fascia of a vehicle, a center information display (“CID”) disposed on a dashboard of a vehicle, a room mirror display replacing side mirrors of a vehicle, or a display disposed on the back of a front seat as an entertainment for rear-seat passengers of a vehicle.

The image display device 10 in the embodiment may be a light-emitting display device such as an organic light-emitting display device using an organic light-emitting diode, a quantum dot light-emitting display device including a quantum dot light-emitting layer, an inorganic light-emitting display device including an inorganic semiconductor, or an ultrasmall light-emitting display device including an ultrasmall light-emitting diode (a micro-light-emitting diode or nano-light-emitting diode). A case where the image display device 10 in the embodiment is an organic light-emitting display device will be mainly described below, but the disclosure is not limited thereto.

The image display device 10 in the embodiment includes a display panel 100, a display driving circuit 200, a display circuit board 300, and a touch sensing circuit 400. The image display device 10 uses the touch input device 500 as a touch input mechanism, in addition to a body part such as a finger. The display panel 100 of the image display device 10 includes a display unit DU which displays an image and a touch sensing unit TSU which senses a body part such as a finger and the touch input device 500.

The touch input device 500 may be formed as an electronic pen type such as a stylus pen. The touch input device 500 may receive a touch driving signal from the touch sensing unit TSU at the front of the display panel 100 and transmit a touch data signal to the touch sensing unit TSU.

The display panel 100 of the image display device 10 may be shaped like a quadrangular, e.g., rectangular plane including short sides in a first direction (X-axis direction) and long sides in a second direction (Y-axis direction) intersecting the first direction (X-axis direction). Each corner where a short side extending in the first direction (X-axis direction) meets a long side extending in the second direction (Y-axis direction) may be rounded to have a predetermined curvature or may be right-angled. The planar shape of the display panel 100 is not limited to a quadrilateral shape but may also be other polygonal shapes, a circular shape, or an oval shape. The display panel 100 may be formed flat, but the disclosure is not limited thereto. In an embodiment, the display panel 100 may include a curved portion formed at left and right ends and having a constant or varying curvature, for example. In addition, the display panel 100 may be flexible so that it may be curved, bent, folded, or rolled.

The display panel 100 may include a main area MA and a sub-area SBA.

The main area MA includes a display area DA displaying an image and a non-display area NDA disposed around the display area DA. The display area DA includes pixels which display an image. The display area DA may emit light from an emission area of each pixel or a plurality of opening areas. In an embodiment, the display panel 100 may include pixel circuits including switching elements, a pixel defining layer defining the emission areas or the opening areas, and self-light-emitting elements, for example. In an embodiment, each of the self-light-emitting elements may include, but is not limited to, at least one of an organic light-emitting diode including an organic light-emitting layer, a quantum dot light-emitting diode including a quantum dot light-emitting layer, and an inorganic light-emitting diode including an inorganic semiconductor, for example.

The non-display area NDA may be an area outside the display area DA. The non-display area NDA may be defined as an edge area of the main area MA of the display panel 100. The non-display area NDA may include a gate driver which supplies gate signals to gate lines and fan-out lines which connect the display driving circuit 200 and the display area DA.

The sub-area SBA may protrude from a side of the main area MA in the second direction (Y-axis direction).

Although the sub-area SBA is unfolded in FIGS. 1 and 2, it may also be bent as illustrated in FIG. 3. In this case, the sub-area SBA may be disposed on a back surface of the display panel 100. When the sub-area SBA is bent, it may be overlapped by the main area MA in a third direction (Z-axis direction) which is a thickness direction of a substrate SUB. The display driving circuit 200 may be disposed in the sub-area SBA.

In addition, the display panel 100 may include the display unit (also referred to as display module) DU including the substrate SUB, a thin-film transistor layer TFTL, a light-emitting element layer EML and an encapsulation layer TFEL and the touch sensing unit TSU formed on a front surface of the display module DU as illustrated in FIG. 3.

The thin-film transistor layer TFTL may be disposed on the substrate SUB. The thin-film transistor layer TFTL may be disposed in the main area MA and the sub-area SBA. The thin-film transistor layer TFTL includes thin-film transistors.

The light-emitting element layer EML may be disposed on the thin-film transistor layer TFTL. The light-emitting element layer EML may be disposed in the display area DA of the main area MA. The light-emitting element layer EML includes light-emitting elements disposed in light-emitting units.

The encapsulation layer TFEL may be disposed on the light-emitting element layer EML. The encapsulation layer TFEL may be disposed in the display area DA and the non-display area NDA of the main area MA. The encapsulation layer TFEL includes at least one inorganic layer and at least one organic layer to encapsulate the light-emitting element layer EML.

The touch sensing unit TSU may be formed integrally with the display panel 100 or may be formed separately and then disposed (e.g., mounted) or assembled on a front surface of the display panel 100. The touch sensing unit TSU may be formed integrally with the encapsulation layer TFEL or may be disposed (e.g., mounted) on the encapsulation layer TFEL to detect a touch position of a user's body part such as a finger or the touch input device 500.

A cover window may be disposed on the touch sensing unit TSU to protect an upper portion of the display panel 100. The cover window may be attached onto the touch sensing unit TSU by a transparent adhesive member such as an optically clear adhesive (“OCA”) film or an optically clear resin (“OCR”). The cover window may be an inorganic material such as glass or may be an organic material such as plastic or a polymer material. In order to prevent deterioration of image visibility due to reflection of external light, a polarizing film may be additionally disposed between the touch sensing unit TSU and the cover window.

The display driving circuit 200 may generate control signals and data voltages for driving the display panel 100. The display driving circuit 200 may be formed as an integrated circuit and attached onto the display panel 100 using a chip-on-glass (“COG”) method, a chip-on-plastic (“COP”) method, or an ultrasonic bonding method. However, the disclosure is not limited thereto. In an embodiment, the display driving circuit 200 may also be attached onto the display circuit board 300 using a chip-on-film (“COF”) method, for example.

The display circuit board 300 may be attached to an end of the sub-area SBA of the display panel 100. Accordingly, the display circuit board 300 may be electrically connected to the display panel 100 and the display driving circuit 200. The display panel 100 and the display driving circuit 200 may receive digital video data, timing control signals, and driving voltages through the display circuit board 300. The display circuit board 300 may be a flexible printed circuit board, a printed circuit board, or a flexible film such as a chip-on-film.

The touch sensing circuit 400 may be disposed on the display circuit board 300. The touch sensing circuit 400 may be formed as an integrated circuit and attached to the display circuit board 300. In an alternative embodiment, the touch sensing circuit 400 may be attached onto the display circuit board 300 by the COF method.

The touch sensing circuit 400 may be electrically connected to touch electrodes of the touch sensing unit TSU to detect a touch and touch position of a user's body part such as a finger or the touch input device 500. Specifically, the touch sensing circuit 400 transmits touch driving signals for sensing a body part or the touch input device 500 to the touch electrodes of the touch sensing unit TSU during a touch electrode driving period, i.e., an uplink period. Then, it measures the amount of charge change in the mutual capacitance of each of a plurality of touch nodes formed by the touch electrodes during the uplink period. The touch input device 500 wirelessly receives touch driving signals of a predetermined frequency band transmitted to the touch electrodes of the touch sensing unit TSU while being disposed in proximity to or in contact with the touch sensing unit TSU. Therefore, the mutual capacitance of each of the touch nodes is changed by a touch operation of a body part or the touch input device 500. Accordingly, the touch sensing circuit 400 may measure a change in the capacitance of each of the touch nodes according to a change in the voltage magnitude or current amount of a touch sensing signal received from each of the touch electrodes. In this way, the touch sensing circuit 400 may determine whether a touch or proximity of a body part or the touch input device 500 has occurred based on the amount of charge change in the mutual capacitance of each of the touch nodes of the touch sensing unit TSU during the uplink period. Here, the touch of the body part or the touch input device 500 indicates that the body part or the touch input device 500 directly contacts a surface of the cover window disposed on the touch sensing unit TSU. The proximity of a user indicates that the user's body part hovers above the surface of the cover window.

While being disposed in proximity to or in contact with the touch sensing unit TSU, the touch input device 500 wirelessly receives touch driving signals of a predetermined frequency band, which are transmitted to the touch electrodes of the touch sensing unit TSU, in each signal reception period according to a signal reception mode. The touch input device 500 may charge the touch driving signals of the predetermined frequency band into a capacitive state. To this end, the touch input device 500 may include a first signal transceiver formed as a lead type such as a stylus pen, a second signal transceiver formed as a coil type, a third signal transceiver formed as a ring type, and a battery.

The touch sensing circuit 400 detects touch sensing signals of a predetermined frequency band output from the touch electrodes during a sensing signal detection period, i.e., a downlink period after the uplink period in which the touch electrodes are driven.

While being disposed in proximity to or in contact with the touch sensing unit TSU, the touch input device 500 generates a touch data signal based on pressure data and tilt data and wirelessly transmits the touch data signal to the touch sensing unit TSU in each signal transmission period according to a signal transmission mode. Accordingly, the touch sensing circuit 400 determines whether the touch input device 500 is in proximity and a touch position of the touch input device 500 based on the amount of change in the amplitude of each of the touch sensing signals detected in a predetermined frequency band through at least one touch electrode in each downlink period. Then, it extracts the pressure data and the tilt data by sampling, digitally modulating, and analyzing the amount of change in the amplitude and pulse width of each of the touch sensing signals detected through at least one touch electrode.

The touch input device 500 may be a stylus pen that supports electromagnetic resonance through the first signal transceiver formed as a lead type, the second signal transceiver formed as a coil type, and the third signal transceiver formed as a ring type. The touch input device 500 is charged in response to a magnetic field or electromagnetic signal of the touch sensing unit TSU during a signal reception period and outputs a radio frequency signal corresponding to a touch data signal during a signal transmission period.

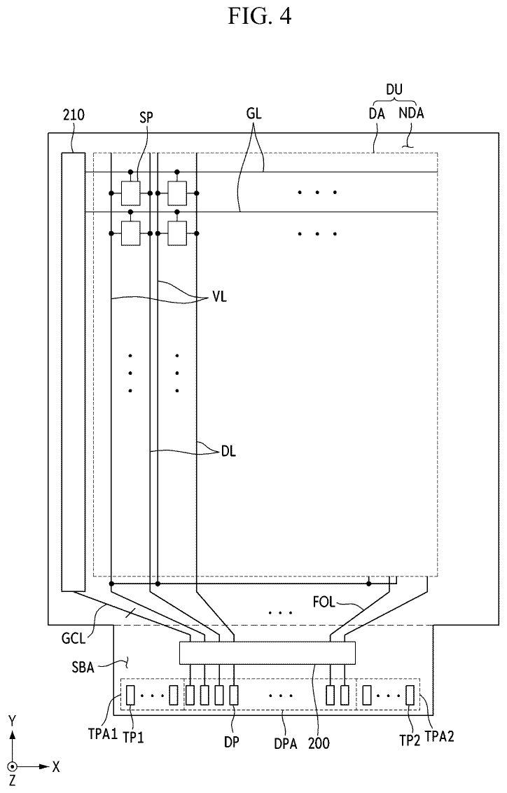

FIG. 4 is a schematic plan view of an embodiment of the display panel 100 illustrated in FIGS. 1 through 3. Specifically, FIG. 4 is a plan view illustrating the display area DA and the non-display area NDA of the display module DU before the touch sensing unit TSU is formed.

The display area DA is an area for displaying an image and may be defined as a central area of the display panel 100. The display area DA may include a plurality of pixels SP, a plurality of gate lines GL, a plurality of data lines DL, and a plurality of power lines VL. Each of the pixels SP may be defined as a minimum unit that outputs light.

The gate lines GL may supply gate signals received from a gate driver 210 to the pixels SP. The gate lines GL may extend in the X-axis direction and may be spaced apart from each other in the Y-axis direction intersecting the X-axis direction.

The data lines DL may supply data voltages received from the display driving circuit 200 to the pixels SP. The data lines DL may extend in the Y-axis direction and may be spaced apart from each other in the X-axis direction.

The power lines VL may supply a power supply voltage received from the display driving circuit 200 to the pixels SP. Here, the power supply voltage may be at least one of a driving voltage, an initialization voltage, and a reference voltage. The power lines VL may extend in the Y-axis direction and may be spaced apart from each other in the X-axis direction.

The non-display area NDA may surround the display area DA. The non-display area NDA may include the gate driver 210, fan-out lines FOL, and gate control lines GCL. The gate driver 210 may generate a plurality of gate signals based on a gate control signal and may sequentially supply the gate signals to the gate lines GL according to a set order.

The fan-out lines FOL may extend from the display driving circuit 200 to the display area DA. The fan-out lines FOL may supply data voltages received from the display driving circuit 200 to the data lines DL.

The gate control lines GCL may extend from the display driving circuit 200 to the gate driver 210. The gate control lines GCL may supply a gate control signal received from the display driving circuit 200 to the gate driver 210.

The sub-area SBA may include the display driving circuit 200, a display pad area DPA, and first and second touch pad areas TPA1 and TPA2.

The display driving circuit 200 may output timing control signals and data voltages for driving the display panel 100 to the fan-out lines FOL. The display driving circuit 200 generates timing control signals according to a display driving frequency preset based on display control firmware and generates data voltages corresponding to image data. Then, the display driving circuit 200 may supply the data voltages to the data lines DL through the fan-out lines FOL according to the display driving frequency set in the firmware. Here, the data voltages may be supplied to the pixels SP and may determine luminances of the pixels SP. In addition, the display driving circuit 200 may supply the timing control signals generated according to the display driving frequency of the firmware and gate voltage values to the gate driver 210 through the gate control lines GCL.

The display pad area DPA, the first touch pad area TPA1, and the second touch pad area TPA2 may be disposed at an edge of the sub-area SBA. The display pad area DPA, the first touch pad area TPA1, and the second touch pad area TPA2 may be electrically connected to the display circuit board 300 using a low-resistance, high-reliability material such as an anisotropic conductive film or self assembly anisotropic conductive paste (“SAP”).

The display pad area DPA may include a plurality of display pad units. The display pad units may be connected to a main processor, such as a graphics card, through the display circuit board 300. The display pad units may be connected to the display circuit board 300 to receive digital video data and may supply the digital video data to the display driving circuit 200.

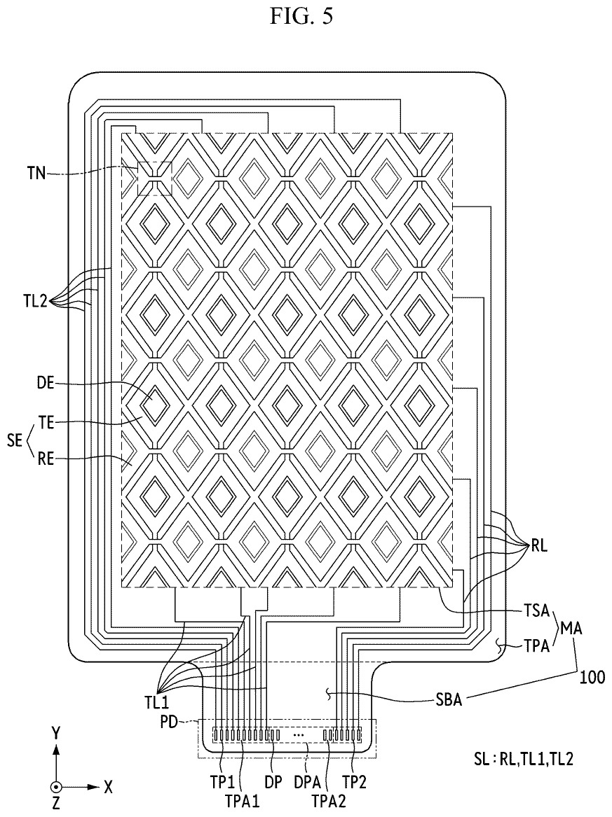

FIG. 5 is a schematic plan view of an embodiment of the touch sensing unit TSU illustrated in FIG. 3.

In FIG. 5, a structure in which touch electrodes SE of the main area MA include two types of electrodes, e.g., driving electrodes TE and sensing electrodes RE will be described as an example. In addition, a case where the touch sensing unit TSU is driven using a mutual capacitance method in which when touch driving signals are transmitted to the driving electrodes TE during a touch electrode driving period, that is, an uplink period, the amount of charge change in the mutual capacitance of each of a plurality of touch nodes is sensed through the sensing electrodes RE will be mainly described below, but the disclosure is not limited thereto. In addition, a discharge amount detection method of the touch input device 500 in which a touch input of the touch input device 500 is detected based on a change in the amplitude of each of sensing signals received through the sensing electrodes RE during a sensing signal detection period, that is, a downlink period will be described in an embodiment, but the disclosure is not limited thereto.

In FIG. 5, only the driving electrodes TE, the sensing electrodes RE, dummy patterns DE, touch lines SL, and first and second touch pads TP1 and TP2 are illustrated for ease of description.

Referring to FIG. 5, the main area MA of the touch sensing unit TSU includes a touch sensing area TSA for sensing a user's touch and a touch peripheral area TPA disposed around the touch sensing area TSA. The touch sensing area TSA may overlap the display area DA of FIGS. 1 through 3, and the touch peripheral area TPA may overlap the non-display area NDA.

The driving electrodes TE, the sensing electrodes RE, and the dummy patterns DE are disposed in the touch sensing area TSA. The driving electrodes TE and the sensing electrodes RE may be electrodes for forming mutual capacitance to sense a touch of an electronic pen or a user's body part.

The sensing electrodes RE may be arranged side by side in the first direction (X-axis direction) and the second direction (Y-axis direction). The sensing electrodes RE may be electrically connected to each other in the first direction (X-axis direction). The sensing electrodes RE next (adjacent) to each other in the first direction (X-axis direction) may be connected to each other. The sensing electrodes RE next (adjacent) to each other in the second direction (the Y-axis direction) may be electrically isolated from each other. Accordingly, a touch node TN having mutual capacitance may be disposed at each of the intersections of the driving electrodes TE and the sensing electrodes RE. The touch nodes TN may correspond to the intersections of the driving electrodes TE and the sensing electrodes RE.

The driving electrodes TE may be arranged side by side in the first direction (X-axis direction) and the second direction (Y-axis direction). The driving electrodes TE next (adjacent) to each other in the first direction (X-axis direction) may be electrically isolated from each other. The driving electrodes TE may be electrically connected to each other in the second direction (Y-axis direction). The driving electrodes TE next (adjacent) to each other in the second direction (Y-axis direction) may be connected to each other through a connection electrode.

Each of the dummy patterns DE may be surrounded by a driving electrode TE or a sensing electrode RE. Each of the dummy patterns DE may be electrically isolated from the driving electrode TE or the sensing electrode RE. Each of the dummy patterns DE may be spaced apart from the driving electrode TE or the sensing electrode RE. Each of the dummy patterns DE may electrically float.

Although each of the driving electrodes TE, the sensing electrodes RE, and the dummy patterns DE has a rhombic planar shape in FIG. 5, the disclosure is not limited thereto. In an embodiment, each of the driving electrodes TE, the sensing electrodes RE, and the dummy patterns DE may also be shaped like a quadrilateral other than a rhombus, a polygon other than a quadrilateral, a circle, or an oval in a plan view, for example.

The touch lines SL may be disposed in the touch peripheral area (also referred to as a sensor peripheral area) TPA. The touch lines SL include first touch driving lines TL1 and second touch driving lines TL2 connected to the driving electrodes TE and touch sensing lines RL connected to the sensing electrodes RE.

The sensing electrodes RE disposed at an end of the touch sensing area TSA may be connected one-to-one to the touch sensing lines RL. In an embodiment, rightmost sensing electrodes RE among the sensing electrodes RE electrically connected to each other in the first direction (X-axis direction) may be respectively connected to the touch sensing lines RL as illustrated in FIG. 5, for example. In addition, the touch sensing lines RL may be connected one-to-one to the second touch pads TP2 disposed in a pad unit PD.

The driving electrodes TE disposed at an end of the touch sensing area TSA may be connected one-to-one to the first touch driving lines TL1, and the driving electrodes TE disposed at an opposite end of the touch sensing area TSA may be connected one-to-one to the second touch driving lines TL2. In an embodiment, lowermost driving electrodes TE among the driving electrodes TE electrically connected to each other in the second direction (Y-axis direction) may be connected to the first touch driving lines TL1, respectively, and uppermost driving electrodes TE may be connected to the second touch driving lines TL2, respectively, for example. The second touch driving lines TL2 may pass outside a left side of the touch sensing area TSA and then may be connected to the driving electrodes TE on an upper side of the touch sensing area TSA.

The first touch driving lines TL1 and the second touch driving lines TL2 may be connected one-to-one to the first touch pads TP1 disposed in the pad unit PD. The driving electrodes TE are connected to the first and second touch driving lines TL1 and TL2 on opposite sides of the touch sensing area TSA to receive touch driving signals.

Therefore, it is possible to prevent a difference between touch driving signals transmitted to the driving electrodes TE disposed on a lower side of the touch sensing area TSA and touch driving signals transmitted to the driving electrodes TE disposed on the upper side of the touch sensing area TSA from occurring due to the resistive-capacitive (“RC”) delay of the touch driving signals.

When the display circuit board 300 is connected to a side of a flexible film (or the display panel) as illustrated in FIGS. 1 through 3, the display pad area DPA and the first and second touch pad areas TPA1 and TPA2 of the pad unit PD may correspond to pads of the display panel 100 connected to the display circuit board 300 (or pads of the display circuit board 300 connected to the display panel 100). Therefore, the pads of the display panel 100 (or the display circuit board) may be placed on display pads DP, the first touch pads TP1 and the second touch pads TP2 to contact them. The display pads DP, the first touch pads TP1, and the second touch pads TP2 may be electrically connected to the pads of the display circuit board 300 using a low-resistance, high-reliability material such as an anisotropic conductive layer or SAP. Therefore, the display pads DP, the first touch pads TP1, and the second touch pads TP2 may be electrically connected to the touch sensing circuit 400 disposed on the display circuit board 300.

The touch sensing circuit 400 generates touch driving signals of a preset frequency band and supplies the touch driving signals to the driving electrodes TE from leftmost driving electrodes TE to rightmost driving electrodes TE in the touch sensing area TSA. Here, the touch sensing circuit 400 may simultaneously supply the touch driving signals to the driving electrodes TE arranged in the second direction (Y-axis direction). In an alternative embodiment, the touch sensing circuit 400 may sequentially supply the touch driving signals to the driving electrodes TE from the leftmost driving electrodes TE to the rightmost driving electrodes TE in the second direction (Y-axis direction).

The touch sensing circuit 400 may divide the driving electrodes TE into a preset number of groups according to programming of touch driving firmware and sequentially output the touch driving signals to the groups of driving electrodes TE. Here, the touch driving signals may be supplied as a plurality of pulse signals generated with a magnitude of about-12 volts (V) to 12 V based on driving voltage values of the firmware.

The touch sensing circuit 400 receives touch sensing signals of a predetermined band output from the sensing electrodes RE through the touch sensing lines RL connected to the sensing electrodes RE. The touch sensing circuit 400 may measure a change in the capacitance of each of the touch nodes through the touch sensing signals of a predetermined frequency band output from at least one sensing electrode RE during the downlink period and detect a touch and touch position of the touch input device 500 or the like. At this time, the touch sensing circuit 400 extracts pressure data and tilt data generated from the touch input device 500 by sampling, digitally modulating, and analyzing the amount of change in the amplitude and pulse width of each of the touch sensing signals detected through at least one sensing electrode RE.

The touch sensing circuit 400 transmits the touch position coordinate data, pressure data and tilt data of the touch input device 500 to the display driving circuit 200 or a graphics system in real time, thereby supporting the generation of touch image data according to touch position coordinates, tilt and pressure by the display driving circuit 200 or the like.

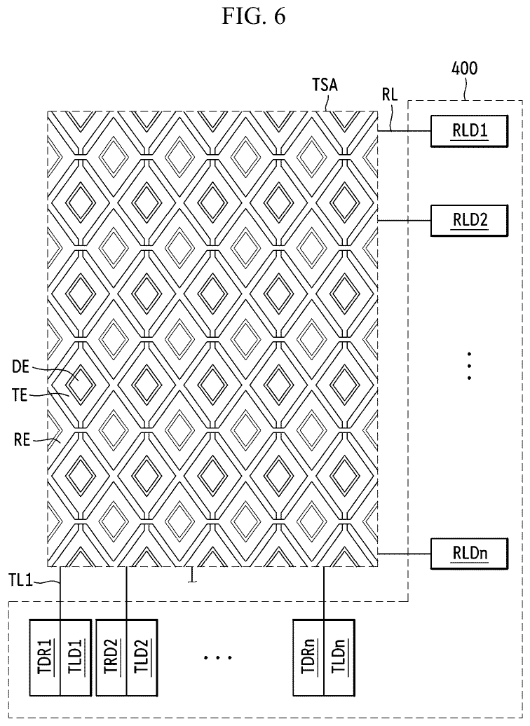

FIG. 6 is a plan view illustrating the electrical connection structure of the touch electrodes SE and the touch sensing circuit 400 illustrated in FIG. 5.

Referring to FIG. 6, the touch sensing circuit 400 includes a plurality of driving signal supply units TDR1 through TDRn, a plurality of signal analysis circuit units TLD1 through TLDn, and a plurality of sensing signal analysis units RLD1 through RLDn. Here, n is a positive integer.

The driving signal supply units TDR1 through TDRn may be selectively connected to odd-numbered or odd-numbered groups of driving electrodes TE of the touch sensing area TSA through odd-numbered first touch driving lines TL1 and switches. In addition, the driving signal supply units TDR1 through TDRn may be selectively connected to the odd-numbered or odd-numbered groups of driving electrodes TE of the touch sensing area TSA through odd-numbered groups of first or second touch driving lines TL1 or TL2 and switches.

In an alternative embodiment, the driving signal supply units TDR1 through TDRn may be selectively connected to even-numbered or even-numbered groups of driving electrodes TE of the touch sensing area TSA through even-numbered first touch driving lines TL1 and switches. In addition, the driving signal supply units TDR1 through TDRn may be selectively connected to the even-numbered or even-numbered groups of driving electrodes TE of the touch sensing area TSA through even-numbered groups of first or second touch driving lines TL1 or TL2 and switches.

In an embodiment, a case where the driving signal supply units TDR1 through TDRn are selectively connected to the odd-numbered or odd-numbered groups of driving electrodes TE of the touch sensing area TSA through the odd-numbered first touch driving lines TL1 during a touch electrode driving period will be described below, for example.

The driving signal supply units TDR1 through TDRn may supply touch driving signals of a predetermined frequency band to the odd-numbered or odd-numbered groups of driving electrodes TE of the touch sensing area TSA during an uplink period.

The driving signal supply units TDR1 through TDRn may sequentially operate from a first driving signal supply unit TDR1 to an n^{th} driving signal supply unit TDRn to sequentially supply the touch driving signals to the odd-numbered or odd-numbered groups of driving electrodes TE from odd-numbered driving electrodes TE arranged on one side of the touch sensing area TSA to odd-numbered driving electrodes TE arranged on an opposite side. In an alternative embodiment, odd-numbered or odd-numbered groups of driving signal supply units TDR1, TDR3, . . . TDRn-1 may simultaneously supply the touch driving signals to the odd-numbered or odd-numbered groups of driving electrodes TE.

In addition, the driving signal supply units TDR1 through TDRn may divide the driving electrodes TE into a preset number of groups and sequentially supply the touch driving signals to odd-numbered or even-numbered groups of driving electrodes TE.

The sensing signal analysis units RLD1 through RLDn are connected one-to-one to the sensing electrodes RE of the touch sensing area TSA through the touch sensing lines RL, respectively.

The sensing signal analysis units RLD1 through RLDn detect touch sensing signals of a predetermined frequency band output from the sensing electrodes RE during a downlink period after the uplink period and detect changes in the voltage magnitudes of the touch sensing signals. In other words, the sensing signal analysis units RLD1 through RLDn may detect the amounts of charge change in mutual capacitances applied to the touch nodes according to changes in the current amounts or voltage magnitudes of the touch sensing signals sequentially or simultaneously output from the sensing electrodes RE during the uplink period. The sensing signal analysis units RLD1 through RLDn may detect a touch of the touch input device 500 and a touch position of the touch input device 500 in one axis direction (e.g., the Y-axis direction) according to changes in the amplitudes of the touch sensing signals sequentially or simultaneously output from the sensing electrodes RE.

The signal analysis circuit units TLD1 through TLDn may be selectively connected to the even-numbered driving electrodes TE of the touch sensing area TSA through the even-numbered first touch driving lines TL1 and switches. In addition, the signal analysis circuit units TLD1 through TLDn may be selectively connected to the even-numbered or even-numbered groups of driving electrodes TE of the touch sensing area TSA through the even-numbered groups of first or second touch driving lines TL1 or TL2 and switches.

In an alternative embodiment, the signal analysis circuit units TLD1 through TLDn may be selectively connected to the odd-numbered driving electrodes TE of the touch sensing area TSA through the odd-numbered first touch driving lines TL1 and switches. In addition, the signal analysis circuit units TLD1 through TLDn may be selectively connected to the odd-numbered or odd-numbered groups of driving electrodes TE of the touch sensing area TSA through the odd-numbered groups of first or second touch driving lines TL1 or TL2 and switches.

In an embodiment, a case where the signal analysis circuit units TLD1 through TLDn are selectively connected to the even-numbered or even-numbered groups of driving electrodes TE in the downlink period after the uplink period will be described below, for example.

The signal analysis circuit units TLD1 through TLDn detect touch sensing signals of a predetermined frequency band output from the even-numbered or even-numbered groups of driving electrodes TE during the downlink period and detect changes in the amplitudes of the touch sensing signals. In other words, the signal analysis circuit units TLD1 through TLDn may detect a touch of the touch input device 500 and a touch position of the touch input device 500 in one axis direction (e.g., the X-axis direction) according to changes in the amplitudes of the touch sensing signals sequentially or simultaneously output from the even-numbered or even-numbered groups of driving electrodes TE during the downlink period.

The signal analysis circuit units TLD1 through TLDn may detect changes in the amplitudes of the touch sensing signals sequentially input thereto from a first signal analysis circuit unit TLD1 to an n^{th} signal analysis circuit TLDn. In an alternative embodiment, the signal analysis circuit units TLD1 through TLDn may detect changes in the amplitudes of the touch sensing signals simultaneously received through the even-numbered or even-numbered groups of driving electrodes TE. The signal analysis circuit units TLD1 through TLDn may also detect changes in the amplitudes of the touch sensing signals sequentially received from the odd-numbered or even-numbered groups of driving electrodes TE.

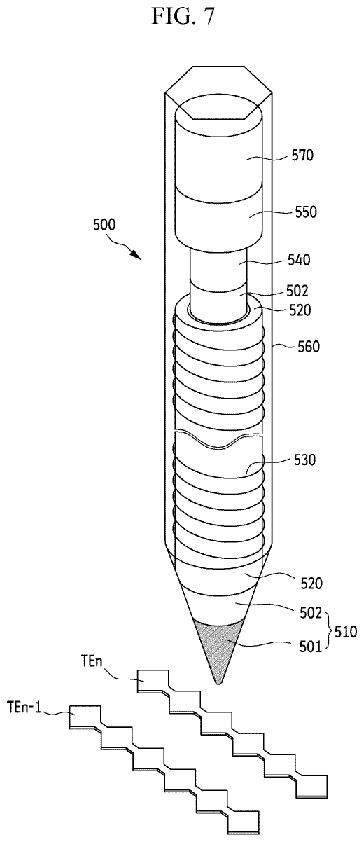

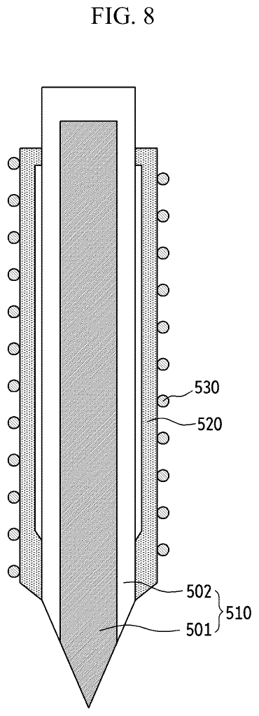

FIG. 7 is a detailed configuration diagram of an embodiment of the touch input device 500 illustrated in FIG. 1. In addition, FIG. 8 is a cross-sectional view illustrating the arrangement structure of a first signal transceiver 510, an insulating member 520, and a second signal transceiver 530 illustrated in FIG. 7.

Referring to FIGS. 7 and 8, the touch input device 500 includes the first signal transceiver 510, the insulating member 520, the second signal transceiver 530, a pressure sensor 540, a touch input controller 550, a battery 570, and a case 560.

The first signal transceiver 510 may include one end forming a pen tip and may be formed as a pen lead type. During a touch driving signal reception period, the first signal transceiver 510 receives a touch driving signal of a predetermined frequency band transmitted to at least one driving electrode, e.g., n^{th} and (n-1)^{th} driving electrodes TEn and TEn-1 under the control of the touch input controller 550. The received touch driving signal may be transmitted to the touch input controller 550 and the battery in real time.

In addition, during a touch data signal transmission period, the first signal transceiver 510 wirelessly transmits a touch data signal, which is received from the touch input controller 550, in a preset frequency band by being electromagnetically linked with the second signal transceiver 530.

Referring to FIG. 8, the first signal transceiver 510 includes a rod-shaped center electrode 501 and a cylindrical metal electrode 502 covering the rod-shaped center electrode 501.

Specifically, the rod-shaped center electrode 501 of the first signal transceiver 510 is formed as a pen lead type with one end forming a pen tip and an opposite end electrically connected to a touch data signal output terminal of the touch input controller 550.

The rod-shaped center electrode 501 includes or consists of a magnetic material such as ferrite and wirelessly transmits a touch data signal, which is received from the touch input controller 550, in a preset frequency band by being electromagnetically linked with the second signal transceiver 530 during the touch data signal transmission period.

The cylindrical metal electrode 502 is formed in a cylindrical shape to cover an opposite end and outer circumferential surface of the rod-shaped center electrode 501, excluding the pen tip. The cylindrical metal electrode 502 includes or consists of at least one metal material or alloy material such as copper, silver, aluminum, phosphoric acid, or iron.

Either one end or an opposite end of the cylindrical metal electrode 502 is electrically connected to a touch driving signal input terminal of the touch input controller 550. The cylindrical metal electrode 502 receives a touch driving signal of a predetermined frequency band transmitted to at least one driving electrode, e.g., the n^{th} and (n-1)^{th} driving electrodes TEn and TEn-1 under the control of the touch input controller 550 during the touch driving signal reception period. At this time, the received touch driving signal is transmitted to the touch input controller 550 and the battery in real time.

The insulating member 520 is formed to cover, in a circular or polygonal cylindrical shape, an outer surface of the cylindrical metal electrode 502 that forms the outer shape of the first signal transceiver 510. The insulating member 520 includes or consists of an insulating material such as silicon, rubber, or an inorganic material.

The second signal transceiver 530 is a coil-type metal wire and is formed to cover an outer surface of the insulating member 520 in a coil type. The second signal transceiver 530 may include one end electrically connected to the touch data signal output terminal of the touch input controller 550 and may be connected in a parallel structure to the rod-shaped center electrode 501. Accordingly, the coil-type second signal transceiver 530 transmits a touch data signal, which is received from the touch input controller 550, as a wireless signal of a preset frequency band during the touch data signal transmission period.

The pressure sensor 540 senses pressure applied to the first signal transceiver 510, generates a pressure sensing signal corresponding to the magnitude of the pressure, and transmits the pressure sensing signal to the touch input controller 550. The pressure sensor 540 may be formed as a piezoelectric element type in which an organic material layer 543 whose resistance varies according to volume that varies according to the pressure applied is disposed between first and second piezoelectric electrodes 541 and 542 disposed in parallel to face each other. The pressure sensor 540 is disposed in an area between an opposite end of the first signal transceiver 510 and the touch input controller 550 and generates an analog pressure sensing signal whose voltage magnitude varies according to the pressure applied to the first signal transceiver 510 through the pen tip of the first signal transceiver 510. Then, the analog pressure sensing signal is supplied to the touch input controller 550.

The touch input controller 550 generates pressure data by sampling and digitally modulating the analog pressure sensing signal received from the pressure sensor 540.

In addition, the touch input controller 550 alternately and repeatedly sets the touch driving signal reception period and the touch data signal transmission period. Here, the touch driving signal reception period is a period for receiving a touch driving signal through the cylindrical metal electrode 502 of the first signal transceiver 510. In addition, the touch data signal transmission period is a period for transmitting a touch data signal through the rod-shaped center electrode 501 of the first signal transceiver 510 and the coil-shaped second signal transceiver 530.

The touch input controller 550 is electrically connected to the cylindrical metal electrode 502 and performs a switching operation during the touch driving signal reception period to receive a touch driving signal through the cylindrical metal electrode 502. At this time, the touch input controller 550 may perform a switching operation to allow the touch driving signal received through the cylindrical metal electrode 502 to be supplied to the battery 570.

The battery 570 performs a touch driving voltage charging/discharging operation according to a switching control operation of the touch input controller 550.

The touch input controller 550 generates a touch data signal, which includes a digital pressure code and a pressure value of pressure data, in a preset frequency band during the touch data signal transmission period. Then, the touch input controller 550 is electrically connected to the rod-shaped center electrode 501 and the coil-shaped second signal transceiver 530 and performs a switching operation to simultaneously supply the touch data signal to the rod-shaped center electrode 501 and the coil-shaped second signal transceiver 530. Accordingly, the rod-shaped center electrode 501 and the coil-shaped second signal transceiver 530 may transmit the touch data signal as a wireless signal in the preset frequency band.

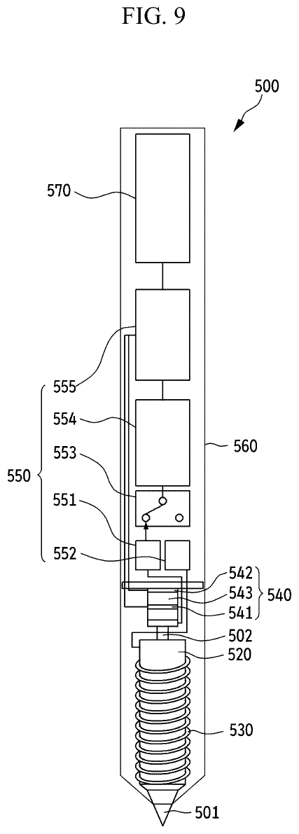

FIG. 9 is a configuration block diagram specifically illustrating detailed components of the touch input device 500 illustrated in FIG. 7. Specifically, FIG. 9 illustrates detailed components of the touch input controller 550 of FIG. 7 in the form of blocks.

Referring to FIG. 9, the touch input controller 550 includes a touch driving signal input channel unit 551, a touch data signal output channel unit 552, a switching unit 553, a switching controller 554, and a micro-control unit 555.

The touch driving signal input channel unit 551 is electrically connected to the cylindrical metal electrode 502 of the first signal transceiver 510 and electrically connected to the micro-control unit 555 by the switching unit 553 during a touch driving signal reception period according to a control operation of the switching controller 554. When electrically connected to the micro-control unit 555 by the switching unit 553, the touch driving signal input channel unit 551 receives a touch driving signal from the cylindrical metal electrode 502 and transmits the touch driving signal to the battery 570 and the micro-control unit 555.

The touch data signal output channel unit 552 is connected in a parallel structure to the rod-shaped center electrode 501 of the first signal transceiver 510 and the second signal transceiver 530. The touch data signal output channel unit 552 is electrically connected to the micro-control unit 555 by the switching unit 553 during a touch data signal transmission period according to the control operation of the switching controller 554. The touch data signal output channel unit 552 transmits a touch data signal supplied from the micro-control unit 555 to the rod-shaped center electrode 501 of the first signal transceiver 510 and the second signal transceiver 530 during the touch data signal transmission period.

The switching unit 553 selectively connects the micro-control unit 555 to the touch driving signal input channel unit 551 or the touch data signal output channel unit 552 in response to the switching control operation of the switching controller 554.

In other words, the switching unit 553 electrically connects the touch driving signal input channel unit 551 to the micro-control unit 555 and the battery 570 according to the switching control operation of the switching controller 554 during the touch driving signal reception period.

The switching unit 553 electrically connects the micro-control unit 555 to the touch data signal output channel unit 552 according to the switching control operation of the switching controller 554 during the touch data signal transmission period.

The switching controller 554 controls the switching operation of the switching unit 553 to electrically connect the touch driving signal input channel unit 551 or the touch data signal output channel unit 552 to the micro-control unit 555 in each touch driving signal reception period or each touch data signal transmission period set by the micro-control unit 555.

The micro-control unit 555 alternately and sequentially sets a period of receiving a touch driving signal through the cylindrical metal electrode 502 of the first signal transceiver 510 and a period of transmitting a touch data signal through the rod-shaped center electrode 501 of the first signal transceiver 510 and the coil-shaped second signal transceiver 530. Then, the micro-control unit 555 may control the switching operation of the switching unit 553 through the switching controller 554 by supplying touch driving signal reception period setting information and touch data signal transmission period setting information to the switching controller 554.

In addition, the micro-control unit 555 receives an analog pressure sensing signal from the pressure sensor 540 and generates pressure data by sampling and digitally modulating the pressure sensing signal. Then, during the touch data signal transmission period, the micro-control unit 555 generates a touch data signal including a digital pressure code and a pressure value of the pressure data and transmits the touch data signal to the touch data signal output channel unit 552 through the switching unit 553.

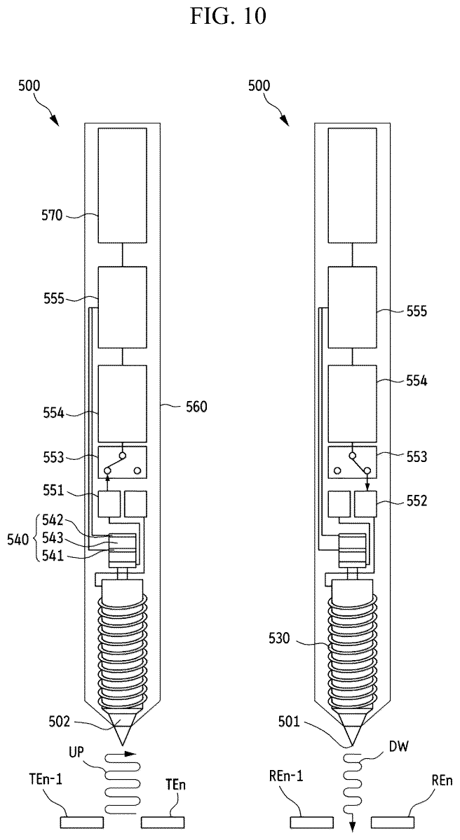

FIG. 10 is a configuration block diagram of the embodiment of FIG. 7, sequentially illustrating touch input signal transmission and reception operations in uplink and downlink periods.

Referring to FIG. 10, during a touch driving signal reception period, the switching unit 553 electrically connects the touch driving signal input channel unit 551 to the micro-control unit 555 and the battery 570 according to the switching control operation of the switching controller 554. Accordingly, the touch driving signal input channel unit 551 is electrically connected to the micro-control unit 555 and the battery 570 while being electrically connected to the cylindrical metal electrode 502 of the first signal transceiver 510. Accordingly, during the touch driving signal reception period, the cylindrical metal electrode 502 receives a touch driving signal of a predetermined frequency band transmitted to at least one nearest driving electrode, e.g., the n^{th} and (n-1)th driving electrodes TEn and TEn-1 (refer to the direction of an arrow UP). Then, it transmits the received touch driving signal of the predetermined frequency band to the touch driving signal input channel unit 551. Accordingly, the touch driving signal input from the cylindrical metal electrode 502 may be supplied to the micro-control unit 555 and the battery 570 through the switching unit 553.

During a touch data signal transmission period, the switching unit 553 electrically connects the micro-control unit 555 to the touch data signal output channel unit 552 according to the switching control operation of the switching controller 554. Accordingly, the micro-control unit 555 generates a touch data signal and transmits the touch data signal to the touch data signal output channel unit 552 through the switching unit 553. The rod-shaped center electrode 501 and the coil-shaped second signal transceiver 530 transmit the touch data signal, which is received through the touch data signal output channel unit 552, as a wireless signal of a preset frequency band.

At this time, an electromagnetic field may be formed between the rod-shaped center electrode 501, which is a magnetic material, and the coil-shaped second signal transceiver 530, and wireless signals of a predetermined frequency band may be concentrated on the rod-shaped center electrode 501 having magnetic force and may be transmitted most greatly through the pen tip of the rod-shaped center electrode 501 (refer to the direction of an arrow DP). Therefore, touch data signals may be transmitted and output to nearest sensing electrodes, e.g., n^{th} and (n-1)^{th} sensing electrodes REn and REn-1 through the pen tip of the rod-shaped center electrode 501. Accordingly, the touch data signals may be concentrated on the rod-shaped center electrode 501 without being dispersed to surrounding structures or body parts and may be efficiently transmitted to the sensing electrodes through the pen tip of the rod-shaped center electrode 501.

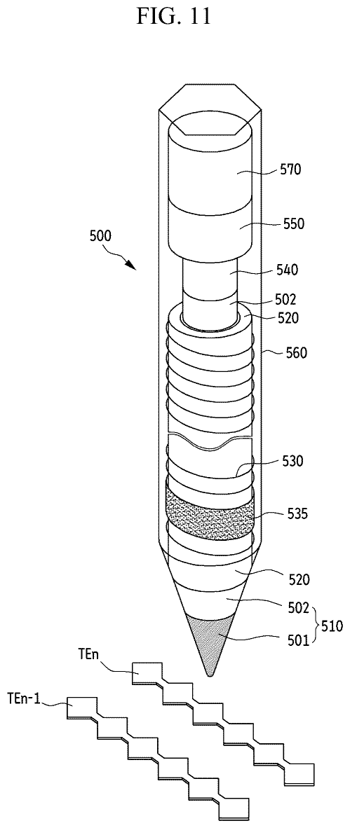

FIG. 11 is a detailed configuration diagram of an embodiment of the touch input device 500 illustrated in FIG. 1.

Referring to FIG. 11, a touch input device 500 further includes a third signal transceiver 535 formed to cover, in a ring type, a portion of an outermost circumferential surface of a second signal transceiver 530 formed and disposed in a coil shape. Here, the third signal transceiver 535 may be formed as a cylindrical or ring type and may include or consist of at least one metal material or alloy material such as copper, silver, aluminum, phosphoric acid, or iron.

The third signal transceiver 535 may be electrically connected to a micro-control unit 555, etc. When a touch driving signal of a predetermined frequency band is transmitted to at least one nearest driving electrode, e.g., n^{th} and (n-1)^{th} driving electrodes TEn and TEn-1, the third signal transceiver 535 receives the touch driving signal of the predetermined frequency band.

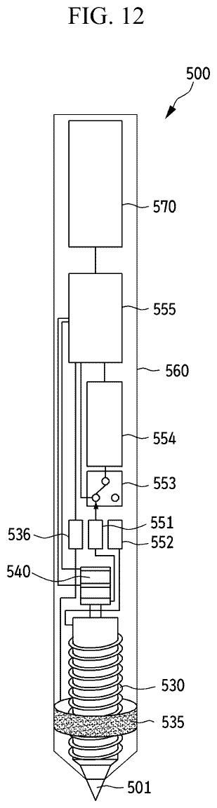

FIG. 12 is a configuration block diagram specifically illustrating detailed components of the touch input device 500 illustrated in FIG. 11.

Referring to FIG. 12, the touch input controller 550 may further include a signal modulator 536 which samples a touch driving signal of a predetermined frequency band received through the third signal transceiver 535, generates first touch driving signal data by digitally modulating the touch driving signal, and supplies the first touch driving signal data to the micro-control unit 555. To this end, the signal modulator 536 may include at least one receiving channel and an analog-digital conversion circuit and may be electrically connected between the third signal transceiver 535 and the micro-control unit 555.

The micro-control unit 555 receives a touch driving signal through a cylindrical metal electrode 502 of a first signal transceiver 510, a touch driving signal input channel unit 551, and a switching unit 553 during a touch driving signal reception period. Then, it generates second touch driving signal data by digitally modulating the touch driving signal received through the switching unit 553.

The micro-control unit 555 compares a driving signal magnitude value of the first touch driving signal data with a driving signal magnitude value of the second touch driving signal data and detects a difference value between them. Then, it generates tilt data which is inversely proportional to the detected difference value. At this time, the micro-control unit 555 determines that the touch input device 500 is tilted more as the detected difference value is smaller and thus generates tilt data including a larger tilt value. The micro-control unit 555 determines that the touch input device 500 is closer to being perpendicular to the display panel 100 as the detected difference value is larger and thus generates tilt data including a smaller tilt value.

The micro-control unit 555 receives an analog pressure sensing signal from a pressure sensor 540 and generates pressure data. Accordingly, the micro-control unit 555 may generate a touch data signal which includes the tilt data including the tilt difference value and a digital pressure code and a pressure value of the pressure data during a touch data signal transmission period. Then, the generated touch data signal is transmitted to a touch data signal output channel unit 552 through the switching unit 553 during the touch data signal transmission period.

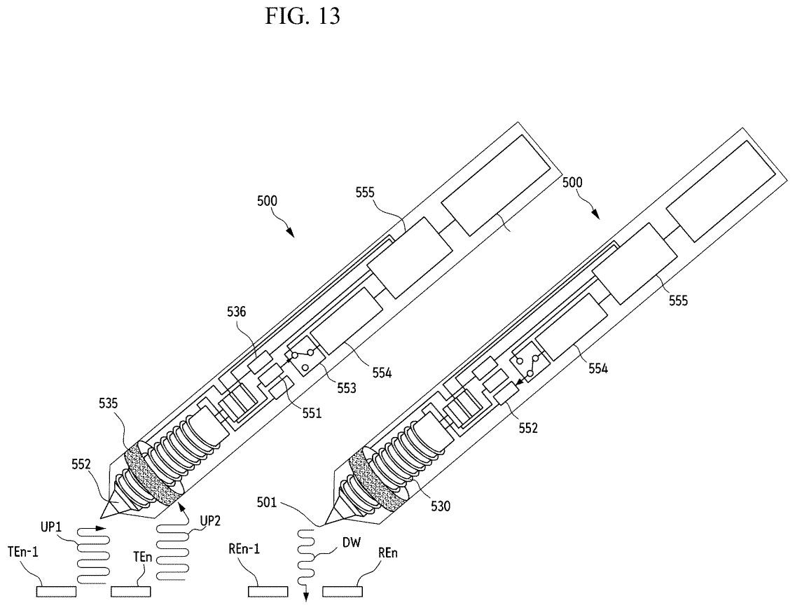

FIG. 13 is a configuration block diagram of the embodiment of FIG. 11, sequentially illustrating touch input signal transmission and reception operations in uplink and downlink periods.

Referring to FIG. 13, during a touch driving signal reception period, the switching unit 553 electrically connects the touch driving signal input channel unit 551 to the micro-control unit 555 and a battery 570 according to a switching control operation of a switching controller 554.

Accordingly, the touch driving signal input channel unit 551 is electrically connected to the micro-control unit 555 and the battery 570 while being electrically connected to the cylindrical metal electrode 502 of the first signal transceiver 510.

During the touch driving signal reception period, the cylindrical metal electrode 502 receives a touch driving signal of a predetermined frequency band transmitted to at least one nearest driving electrode, e.g., n^{th} and (n-1)^{th} driving electrodes TEn and TEn-1 (refer to the direction of an arrow UP1). Then, it transmits the received touch driving signal of the predetermined frequency band to the touch driving signal input channel unit 551. Accordingly, the touch driving signal input from the cylindrical metal electrode 502 may be supplied to the micro-control unit 555 and the battery 570 through the switching unit 553.

During the touch driving signal reception period, the third signal transceiver 535 receives a touch driving signal of a predetermined frequency band transmitted to at least one nearest driving electrode (refer to the direction of an arrow UP2) and transmits the touch driving signal to the signal modulator 536. Accordingly, the signal modulator 536 generates first touch driving signal data by digitally modulating the touch driving signal of the predetermined frequency band received through the third signal transceiver 535 and supplies the first touch driving signal data to the micro-control unit 555.

The micro-control unit 555 generates second touch driving signal data by digitally modulating the touch driving signal received through the switching unit 553 during the touch driving signal reception period. Then, the micro-control unit 555 compares a driving signal magnitude value of the first touch driving signal data with a driving signal magnitude value of the second touch driving signal data and detects a difference value between them. Then, it generates tilt data which is inversely proportional to the detected difference value.

In addition, the micro-control unit 555 receives an analog pressure sensing signal from the pressure sensor 540 and generates pressure data.

During a touch data signal transmission period, the micro-control unit 555 generates a touch data signal which includes the tilt data including the tilt difference value and a digital pressure code and a pressure value of the pressure data. Then, the generated touch data signal is transmitted to the touch data signal output channel unit 552 through the switching unit 553 during the touch data signal transmission period.

Accordingly, a rod-shaped center electrode 501 and the coil-shaped second signal transceiver 530 transmit the touch data signal, which is received through the touch data signal output channel unit 552, as a wireless signal of a preset frequency band.

At this time, an electromagnetic field may be formed between the rod-shaped center electrode 501, which is a magnetic material, and the coil-shaped second signal transceiver 530, and wireless signals of a predetermined frequency band may be concentrated on the rod-shaped center electrode 501 having magnetic force and may be transmitted most greatly through a pen tip of the rod-shaped center electrode 501 (refer to the direction of an arrow DW). Therefore, touch data signals may be transmitted and output to nearest sensing electrodes, e.g., n^{th} and (n-1)^{th} sensing electrodes REn and REn-1 through the pen tip of the rod-shaped center electrode 501. Accordingly, the touch data signals may be concentrated on the rod-shaped center electrode 501 without being dispersed to surrounding structures or body parts and may be efficiently transmitted to the sensing electrodes through the pen tip of the rod-shaped center electrode 501.

In concluding the detailed description, those skilled in the art will appreciate that many variations and modifications may be made to the preferred embodiments without substantially departing from the principles of the disclosure. Therefore, the disclosed preferred embodiments of the disclosure are used in a generic and descriptive sense only and not for purposes of limitation.

What is claimed is:

1. A touch input device comprising:
a first signal transceiver including one end forming a pen tip and formed as a pen lead type;
an insulating member which covers an outer surface of a main body of the first signal transceiver in a circular or polygonal cylindrical shape;
a second signal transceiver which covers the insulating member in a coil shape; and
a touch input controller which sets a touch driving signal reception period of the first signal transceiver and a touch data signal transmission period of the first and second signal transceivers, and sequentially and repeatedly controls a touch driving signal reception operation of the first signal transceiver and a touch data signal transmission operation of the first and second signal transceivers.

2. The touch input device of claim 1, further comprising:
a pressure sensor which generates a pressure sensing signal by sensing pressure applied to the first signal transceiver; and
a battery which charges or discharges a touch driving signal received through the first signal transceiver.

3. The touch input device of claim 2, wherein the first signal transceiver comprises:
a rod-shaped center electrode including one end forming a pen tip and an opposite end electrically connected to a touch data signal output channel unit of the touch input controller; and
a cylindrical metal electrode formed in a cylindrical shape and covering the opposite end and an outer circumferential surface of the rod-shaped center electrode, excluding the pen tip of the rod-shaped center electrode,
wherein any one end of the cylindrical metal electrode is electrically connected to a touch driving signal input channel unit of the touch input controller.

4. The touch input device of claim 3, wherein the rod-shaped center electrode includes a magnetic material comprising ferrite, the cylindrical metal electrode includes a metal material or alloy material comprising at least one of copper, silver, aluminum, phosphoric acid and iron, and the rod-shaped center electrode and the second signal transceiver simultaneously and wirelessly transmit a touch data signal, which is received from the touch input controller, in a preset frequency band.

5. The touch input device of claim 3, wherein the touch input controller comprises:
a switching controller which controls a switching operation of a switching unit to select and electrically connect the touch driving signal input channel unit or the touch data signal output channel unit; and
a micro-control unit which sequentially sets a period of receiving a touch driving signal through the cylindrical metal electrode and a period of transmitting a touch data signal through the rod-shaped center electrode and the second signal transceiver, and controls an operation of receiving the touch driving signal and an operation of transmitting the touch data signal through the switching controller.

6. The touch input device of claim 5, wherein the switching unit selects and electrically connects the touch driving signal input channel unit or the touch data signal output channel unit in the touch driving signal reception period or the touch data signal transmission period, the touch driving signal input channel unit is electrically connected to the cylindrical metal electrode to wirelessly receive a touch driving signal through a touch sensing unit of a display panel, and the touch data signal output channel unit is connected in a parallel structure to the rod-shaped center electrode and the second signal transceiver to supply a touch data signal to the rod-shaped center electrode and the second signal transceiver.

7. The touch input device of claim 5, wherein the micro-control unit alternately and repeatedly sets the touch driving signal reception period for wirelessly receiving a touch driving signal from a touch sensing unit of a display panel through the cylindrical metal electrode and the touch data signal transmission period for transmitting a touch data signal in a preset frequency band through the rod-shaped center electrode and the second signal transceiver and controls the switching controller and the switching unit in the touch driving signal reception period and the touch data signal transmission period.

8. The touch input device of claim 5, wherein the micro-control unit generates digital pressure data by receiving the pressure sensing signal from the pressure sensor, generates a touch data signal, which comprises a digital pressure code and a pressure value of the pressure data, in a preset frequency band, and is electrically connected to the rod-shaped center electrode and the second signal transceiver and performs the switching operation during the touch data signal transmission period to simultaneously transmit the touch data signal to the rod-shaped center electrode and the second signal transceiver.

9. The touch input device of claim 1, further comprising a third signal transceiver which covers, in a cylindrical or ring type, a portion of an outermost circumferential surface of the second signal transceiver formed and disposed in a coil shape, wherein the third signal transceiver includes a metal material or alloy material comprising at least one of copper, silver, aluminum, phosphoric acid, and iron.

10. The touch input device of claim 9, wherein the first signal transceiver comprises:
a rod-shaped center electrode including one end forming a pen tip and an opposite end electrically connected to a touch data signal output channel unit of the touch input controller; and
a cylindrical metal electrode formed in a cylindrical shape to cover the opposite end and an outer circumferential surface of the rod-shaped center electrode, excluding the pen tip of the rod-shaped center electrode,
wherein any one end of the cylindrical metal electrode is electrically connected to a touch driving signal input terminal of the touch input controller.

11. The touch input device of claim 10, wherein the touch input controller comprises:
a switching controller which controls a switching operation of a switching unit to select and electrically connect a touch driving signal input channel unit or the touch data signal output channel unit of the touch input controller;
a micro-control unit which sequentially sets a period of receiving a touch driving signal through the cylindrical metal electrode and a period of transmitting a touch data signal through the rod-shaped center electrode and the second signal transceiver, and controls an operation of receiving the touch driving signal and an operation of transmitting the touch data signal through the switching controller; and
a signal modulator which samples a touch driving signal of a predetermined frequency band received through the third signal transceiver, generates first touch driving signal data by digitally modulating the touch driving signal, and supplies the first touch driving signal data to the micro-control unit.

12. The touch input device of claim 11, wherein the micro-control unit receives the touch driving signal through the cylindrical metal electrode and the touch driving signal input channel unit during the touch driving signal reception period, digitally modulates the touch driving signal, generates second touch driving signal data according to a result of digital modulation, compares a driving signal magnitude value of the first touch driving signal data and a driving signal magnitude value of the second touch driving signal data, and generates tilt data which is inversely proportional to a difference value between the driving signal magnitude value of the first touch driving signal data and the driving signal magnitude value of the second touch driving signal data compared with each other.

13. The touch input device of claim 12, wherein the micro-control unit generates digital pressure data by receiving a pressure sensing signal from a pressure sensor, generates the touch data signal comprising the tilt data and the pressure data during the touch data signal transmission period, and transmits the touch data signal to the touch data signal output channel unit through the switching unit.

14. An image display device comprising:
a display panel including a plurality of pixels arranged in an image display area;
a touch sensing unit disposed on a front surface of the display panel to sense a touch of a user's body part or a touch input device;
a display driving circuit which drives the pixels of the image display area; and
a touch sensing circuit which generates touch coordinate data by detecting a touch position of the user's body part or the touch input device,
wherein the touch sensing circuit detects the touch position of the touch input device by supplying touch driving signals to touch electrodes of the touch sensing unit during an uplink period and receiving sensing signals from the touch electrodes during a downlink period, and the touch input device wirelessly receives the touch driving signals through the touch electrodes during a preset touch driving signal reception period and generates a touch data signal and transmits the touch data signal to the touch electrodes during a preset touch data signal transmission period.

15. The image display device of claim 14, wherein the touch input device comprises:
a first signal transceiver including one end forming a pen tip and formed as a pen lead type;
an insulating member which covers an outer surface of a main body of the first signal transceiver in a circular or polygonal cylindrical shape;
a second signal transceiver which covers the insulating member in a coil shape; and
a touch input controller which sets a touch driving signal reception period of the first signal transceiver and a touch data signal transmission period of the first and second signal transceivers, and sequentially and repeatedly controls a touch driving signal reception operation of the first signal transceiver and a touch data signal transmission operation of the first and second signal transceivers.

16. The image display device of claim 15, wherein the first signal transceiver comprises:
a rod-shaped center electrode including one end forming a pen tip and an opposite end electrically connected to a touch data signal output channel unit of the touch input controller; and
a cylindrical metal electrode formed in a cylindrical shape to cover an opposite end and an outer circumferential surface of the rod-shaped center electrode, excluding the pen tip of the rod-shaped center electrode,
wherein the rod-shaped center electrode includes or consists of a magnetic material comprising ferrite, the cylindrical metal electrode includes or consists of a metal material or alloy material comprising at least one of copper, silver, aluminum, phosphoric acid and iron, and the rod-shaped center electrode and the second signal transceiver simultaneously and wirelessly transmit a touch data signal, which is received from the touch input controller, in a preset frequency band.

17. The image display device of claim 16, wherein the touch input controller comprises:
a switching controller which controls a switching operation of a switching unit to select and electrically connect a touch driving signal input channel unit or the touch data signal output channel unit of the touch input controller; and
a micro-control unit sequentially which setts a period of receiving a touch driving signal through the cylindrical metal electrode and a period of transmitting a touch data signal through the rod-shaped center electrode and the second signal transceiver, and controls an operation of receiving the touch driving signal and an operation of transmitting the touch data signal through the switching controller.

18. The image display device of claim 15, wherein the touch input device further comprises a third signal transceiver which covers, in a cylindrical or ring type, a portion of an outermost circumferential surface of the second signal transceiver formed and disposed in a coil shape, wherein the third signal transceiver includes or consists of a metal material or alloy material comprising at least one of copper, silver, aluminum, phosphoric acid, and iron.

19. The image display device of claim 18, wherein the first signal transceiver comprises:
a rod-shaped center electrode including one end forming a pen tip and an opposite end electrically connected to a touch data signal output channel unit of the touch input controller; and
a cylindrical metal electrode formed in a cylindrical shape to cover an opposite end and an outer circumferential surface of the rod-shaped center electrode, excluding the pen tip of the rod-shaped center electrode,
wherein any one end of the cylindrical metal electrode is electrically connected to a touch driving signal input terminal of the touch input controller.

20. An electronic device including:
an image display device comprising:
a display panel including a plurality of pixels arranged in an image display area;
a touch sensing unit disposed on a front surface of the display panel to sense a touch of a user's body part or a touch input device;
a display driving circuit driving the plurality of pixels of the image display area; and
a touch sensing circuit generating touch coordinate data by detecting a touch position of the user's body part or the touch input device,
wherein the touch sensing circuit detects the touch position of the touch input device by supplying touch driving signals to touch electrodes of the touch sensing unit during an uplink period and receiving sensing signals from the touch electrodes during a downlink period, and the touch input device wirelessly receives the touch driving signals through the touch electrodes during a preset touch driving signal reception period and generates a touch data signal and transmits the touch data signal to the touch electrodes during a preset touch data signal transmission period.
